(19) United States
(12) Patent Application Publication
(10) Pub. No.: US 2026/0189135 A1
(43) Pub. Date: Jul. 2, 2026

(54) BATTERY EMULATOR AND OPERATING METHOD THEREOF

(71) Applicant: PHOENIXON CONTROLS INC, Hwaseong-si (KR)

(72) Inventors: Ki Sool NAH, Hwaseong-si (KR); Hyuk Joo KWEON, Hwaseong-si (KR); Woo Seok LEE, Hwaseong-si (KR)

(21) Appl. No.: 19/426,076

(22) Filed: Dec. 19, 2025

(30) Foreign Application Priority Data
Dec. 27, 2024 (KR) 10-2024-0198426

(51) Int. Cl. H02M 1/42; H02M 1/00; H02M 3/158

(52) U.S. Cl. CPC H02M 1/4216; H02M 1/0067; H02M 1/0083; H02M 3/158

(57) ABSTRACT

Provided are a battery emulator including a first power factor correction circuit, a second power factor correction circuit, a DC-DC converter, and a plurality of relay switches, and an operating method of the battery emulator. The battery emulator enables high-efficiency operation under various output voltage conditions, and facilitates the generation of low voltage output to reduce switching losses and heat generation problems, thereby improving energy efficiency.

### CROSS-REFERENCE TO RELATED APPLICATION

This application is based on and claims the benefit of priority to Korean Patent Application No. 10-2024-0198426, filed Dec. 27, 2024, the aforementioned priority application being hereby incorporated by reference in its entirety.

### TECHNICAL FIELD

The present invention relates to a battery emulator, and more particularly, to a battery emulator and an operating method thereof that enable high-efficiency operation under various output voltage conditions and facilitate the generation of low voltage output.

### BACKGROUND

Recently, the demand for eco-friendly vehicles in the automotive industry has been rapidly increasing. Eco-friendly vehicles are classified into hybrid vehicles, plug-in hybrid vehicles, electric vehicles, and fuel cell vehicles, and electric motors are widely used as the driving source for these vehicles. The electric motor is one of the key components that determine the performance and efficiency of a vehicle, and thus requires thorough performance verification.

To verify the performance of an electric motor, a test environment using a dynamometer is mainly used. At this time, a bidirectional power supply device (battery emulator) is used as the input power source for driving the electric motor. A conventional battery emulator adopts a two-stage structure composed of a 3-phase PFC (Power Factor Correction) and a DC-DC converter. However, this structure fixedly generates a high DC link voltage. Therefore, the conventional battery emulator has a limitation in that when a low voltage output is required, switching loss increases, leading to heat generation problems and low efficiency, and it is difficult to generate a low voltage.

Therefore, there is a need for a battery emulator that facilitates the generation of low voltage while maintaining high efficiency under various output voltage conditions.

### SUMMARY

An object of the present invention is to provide a battery emulator and an operating method thereof that enable high-efficiency operation under various output voltage conditions, and facilitate the generation of low voltage output to reduce switching losses and heat generation problems, thereby improving energy efficiency.

A battery emulator according to an embodiment of the present invention may include a first power factor correction circuit configured to convert a first AC voltage, provided from a 3-phase power source through a connection circuit, into a DC voltage and output it as a first link voltage; a second power factor correction circuit configured to convert a second AC voltage, provided from the 3-phase power source through the connection circuit, into a DC voltage and output it as a second link voltage; a DC-DC converter configured to convert the voltage level of an input voltage and output it; and a plurality of relay switches configured such that, according to a target output voltage, the connection relationship is changed so that each of the first link voltage and the second link voltage is input to the DC-DC converter, or the first link voltage is input to the DC-DC converter.

In one embodiment, the range of the target output voltage may include a first section higher than a first voltage, a second section between a second voltage lower than the first voltage and the first voltage, and a third section lower than the second voltage.

In one embodiment, when the target output voltage corresponds to the first section, the plurality of relay switches may be configured such that the connection relationship is changed so that each of the first link voltage and the second link voltage is input to the DC-DC converter.

In one embodiment, when the target output voltage corresponds to the first section, each of the first power factor correction circuit and the second power factor correction circuit may be configured to linearly vary and output each of the first link voltage and the second link voltage as the target output voltage varies.

In one embodiment, when the target output voltage corresponds to the second section, the plurality of relay switches may be configured such that the connection relationship is changed so that each of the first link voltage and the second link voltage is input to the DC-DC converter.

In one embodiment, when the target output voltage corresponds to the second section, each of the first power factor correction circuit and the second power factor correction circuit is configured to output each of the first voltage and the second link voltage at a minimum voltage, and the DC-DC converter may be configured to receive a control signal in which a duty cycle or switching frequency is varied to generate a voltage corresponding to the target output voltage.

In one embodiment, when the target output voltage corresponds to the third section, the plurality of relay switches may be configured such that the connection relationship is changed so that the first link voltage is input to the DC-DC converter.

In one embodiment, when the target output voltage corresponds to the third section, the first power factor correction circuit is configured to output the first link voltage at a minimum voltage, the second power factor correction circuit is configured to be turned off, and the DC-DC converter may be configured to receive a control signal in which a duty cycle or switching frequency is varied to generate a voltage corresponding to the target output voltage.

In one embodiment, the first power factor correction circuit includes a first output port and a second output port for outputting the first link voltage, the second power factor correction circuit includes a third output port and a fourth output port for outputting the second link voltage, the DC-DC converter includes a first input port, a second input port, and a third input port, and the plurality of relay switches include a first relay switch, one end of which is connected to each of the second output port and the third output port and the other end of which is connected to the second input port, and a second relay switch, one end of which is connected to each of the second output port and the third output port and the other end of which is connected to the third input port, and according to the target output voltage, the plurality of relay switches are configured to change the connection relationship such that the second relay switch is turned off and the first relay switch is turned on, whereby each of the second output port and the third output port is connected to the second input port, so that the first link voltage is input to the DC-DC converter through the first input port and the second input port, and the second link voltage is input to the DC-DC converter through the second input port and the third input port, or, the first relay switch is turned off and the second relay switch is turned on, whereby the third output port is connected with the fourth output port, so that the first link voltage is input to the DC-DC converter through the first input port and the third input port.

An operating method of a battery emulator according to an embodiment of the present invention may include the steps of: in a first power factor correction circuit, converting a first AC voltage provided from a 3-phase power source through a connection circuit into a DC voltage and outputting it as a first link voltage; in a second power factor correction circuit, converting a second AC voltage provided from the 3-phase power source through the connection circuit into a DC voltage and outputting it as a second link voltage; in a DC-DC converter, converting the voltage level of an input voltage and outputting it; and in a plurality of relay switches, changing the connection relationship of the plurality of relay switches according to a target output voltage so that each of the first link voltage and the second link voltage is input to the DC-DC converter or the first link voltage is input to the DC-DC converter.

The battery emulator and operating method thereof according to the present invention enable high-efficiency operation under various output voltage conditions, and facilitate the generation of low voltage output, thereby reducing switching losses and heat generation problems and improving energy efficiency.

### BRIEF DESCRIPTION OF THE DRAWINGS

Embodiments will be more clearly understood from the following detailed description taken in conjunction with the accompanying drawings in which:

FIG. 1 is a block diagram illustrating a schematic configuration of a battery emulator according to an embodiment of the present invention.

FIG. 2 is a circuit diagram specifically illustrating the configuration of a battery emulator according to an embodiment of the present invention.

FIG. 3 to FIG. 6 are diagrams for explaining the specific operation of a battery emulator according to an embodiment of the present invention.

FIG. 7 is an algorithm block diagram for explaining the control operation of the battery emulator by a control circuit according to an embodiment of the present invention.

FIG. 8 is an algorithm block diagram for explaining the control operation of the first PFC control unit of FIG. 7.

FIG. 9 to FIG. 13 are diagrams showing simulation results of a battery emulator according to an embodiment of the present invention.

FIG. 14 is a graph for explaining the loss reduction effect of a battery emulator according to an embodiment of the present invention.

FIG. 15 is a diagram showing a test system including a battery emulator according to an embodiment of the present invention.

### DETAILED DESCRIPTION

Hereinafter, specific embodiments of the present invention will be described in detail with reference to the accompanying drawings. In this specification, detailed descriptions of well-known functions or configurations are omitted when they are deemed to unnecessarily complicate or obscure the core of the invention.

The advantages, features, and methods of achieving them of the disclosed embodiments will be clearly understood by reference to the accompanying drawings and the embodiments described below. However, the present invention is not limited to these embodiments and may be implemented in various forms. These embodiments are provided merely as examples to facilitate a complete understanding of the invention and are not intended to limit the scope of the invention.

In the accompanying drawings, the same or similar components are assigned the same reference numbers. Also, when describing embodiments of the present invention, descriptions of the same or similar components may be omitted to avoid redundant explanations. However, the omission of such a description does not imply that the corresponding component is not included in a particular embodiment.

The terms used in this specification have been chosen to fully reflect the function of the invention and are currently in general use, but they may vary depending on the perspective of technicians in the relevant field or new technological developments. In addition, in certain cases, there may be terms arbitrarily selected by the applicant, and in such cases, their meaning will be described in detail in the specification. Therefore, the terms in this specification should be interpreted based on their meaning and the overall content of the present invention, not just their simple names.

In this specification, when expressed in the singular, it may also include the plural meaning unless explicitly limited to the singular. Conversely, when expressed in the plural, it can be interpreted as singular in context, unless explicitly limited to being plural. Throughout the specification, when a certain part is said to include a certain component, it means that additional components may be included, not that other components are excluded.

In this specification, the expression “each of a plurality of A” or “a plurality of A each” may refer to each of all elements included in the plurality of A, or may refer to each of some elements of the plurality of A.

In this specification, outputting a signal or a signal being activated means that the signal is output at a voltage of the logic that activates the circuit receiving the signal, and not outputting a signal or a signal being deactivated means that the signal is output and maintained at a voltage of the logic that deactivates the circuit receiving the signal. For example, in this specification, outputting a signal (to activate a circuit) may mean outputting a logic high, and not outputting a signal may mean outputting a logic low, but the logic for activating a circuit is not fixed to logic low or logic high, and the present invention is not limited thereto.

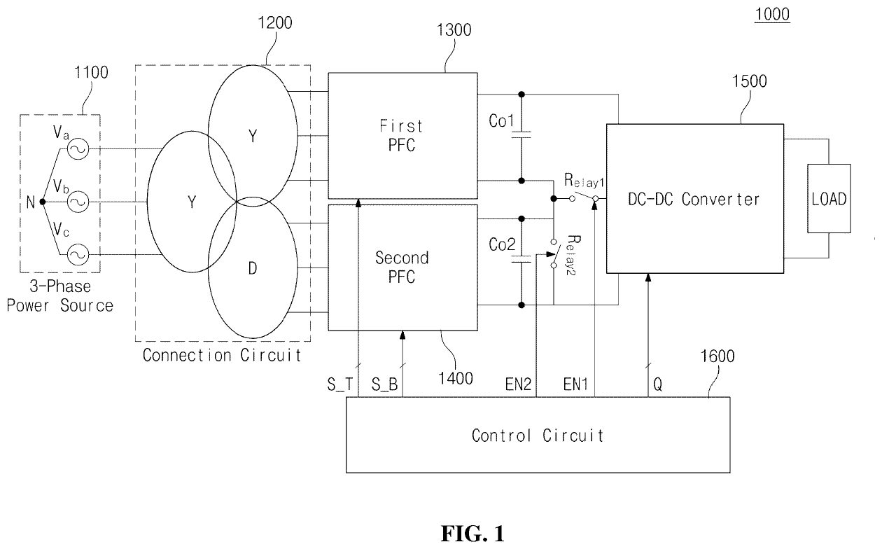

FIG. 1 is a block diagram illustrating a schematic configuration of a battery emulator according to an embodiment of the present invention.

A battery emulator 1000 is a device that supplies power to a load (Load) to perform tests or research under various electrical conditions by simulating the operation of a real battery. The battery emulator 1000 according to an embodiment of the present invention may include a 3-phase power source 1100, a connection circuit 1200, a first power factor correction circuit 1300, a second power factor correction circuit 1400, a DC-DC converter 1500, a control circuit 1600, and a plurality of relay switches.

The 3-phase power source 1100 is a circuit for generating 3-phase voltages (Va, Vb, Vc) to generate AC power of a constant frequency and voltage in each phase. The 3-phase power source 1100 may provide the generated 3-phase voltages (Va, Vb, Vc) to the connection circuit 1200.

The connection circuit 1200 is a circuit for converting the 3-phase voltages (Va, Vb, Vc) provided from the 3-phase power source 1100 by a specified connection method and transmitting them to a subsequent circuit. For example, the connection circuit 1200 may provide a first AC voltage to the first power factor correction circuit 1300 through a Y-connection method, and provide a second AC voltage to the second power factor correction circuit 1400 through a D-connection method. However, this is merely an example, and the connection circuit 1200 can be configured in various forms, for example, it may include only a Y-connection or only a D-connection, but the present invention is not limited thereto.

The first power factor correction circuit 1300 is a circuit that corrects the power factor of the power source to reduce power loss and increase efficiency. In FIG. 1, the first power factor correction circuit 1300 is denoted as a first PFC (Power Factor Correction). The first power factor correction circuit 1300 is configured to convert the first AC voltage provided from the 3-phase power source 1100 through the connection circuit 1200 into a DC voltage and output it as a first link voltage Vlink1. The first power factor correction circuit 1300 operates based on a control signal S_T provided from the control circuit 1600. The control signal S_T may include a plurality of control signals.

The second power factor correction circuit 1400 is configured to convert the second AC voltage provided from the 3-phase power source 1100 through the connection circuit 1200 into a DC voltage and output it as a second link voltage Vlink2. In FIG. 1, the second power factor correction circuit 1400 is denoted as a second PFC. The second power factor correction circuit 1400 operates based on a control signal S_B provided from the control circuit 1600.

The DC-DC converter 1500 is configured to convert the voltage level of the input voltage and output it to a load (Load). The DC-DC converter 1500 receives DC voltages (a first link voltage, a second link voltage) from the first and second power factor correction circuits (1300, 1400), respectively, and adjusts the voltage and current of the input signals to provide them to the load (Load). The DC-DC converter 1500 operates based on a control signal Q provided from the control circuit 1600.

The plurality of relay switches may include a first relay switch Relay1 and a second relay switch Relay2. The plurality of relay switches may be configured such that, according to a target output voltage, the connection relationship is changed so that each of the first link voltage Vlink1 and the second link voltage Vlink2 is input to the DC-DC converter 1500, or the first link voltage Vlink1 is input to the DC-DC converter 1500.

The target output voltage means the voltage that the battery emulator 1000 desires to provide to the load (Load), and it may be predetermined or set by a user, and may be changed during operation. However, this is merely an example and the present invention is not limited thereto.

The control circuit 1600 is a device that controls each component of the battery emulator 1000. The control circuit 1600 can control the operation of the first power factor correction circuit 1300, the second power factor correction circuit 1400, the DC-DC converter 1500, the first relay switch Relay1 and the second relay switch Relay2 through control signals (S_T, S_B, EN1, EN2, Q). The control signals (S_T, S_B, Q) may each include a plurality of control signals. This will be described in detail below.

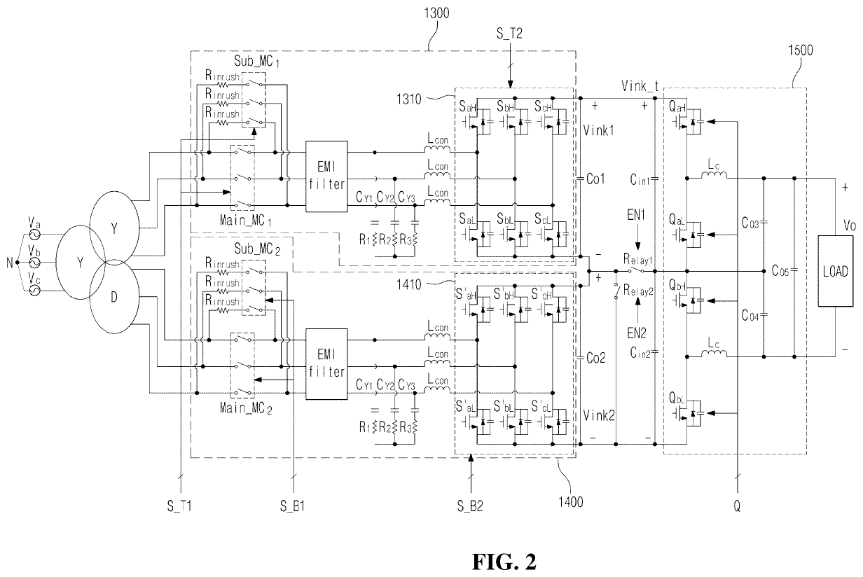

FIG. 2 is a circuit diagram specifically illustrating the configuration of a battery emulator according to an embodiment of the present invention.

The specific configurations of the 3-phase power source 1100 and the connection circuit 1200 are as shown in FIG. 1, so a description thereof is omitted.

The first power factor correction circuit 1300 may include a plurality of resistors R_inrush, a main contactor Main_MC1, an auxiliary contactor Sub_MC1, an EMI filter, a common mode noise filter, and a PWM converter 1310. The first power factor correction circuit 1300 may also include a first output port and a second output port for outputting the first link voltage Vlink1. Among the two output ports of the first power factor correction circuit 1300, the upper port corresponds to the first output port, and the lower port corresponds to the second output port.

The plurality of resistors R_inrush are resistors for limiting inrush current, preventing excessive initial current flow. The auxiliary contactor Sub_MC1 is turned on in the initial stage, allowing current to flow through the plurality of resistors R_inrush to limit the inrush current, and after the initial stage, the auxiliary contactor Sub_MC1 may be turned off and switched to the main contactor Main_MC1. The main contactor Main_MC1 is turned on after the inrush current has stabilized, and can perform normal power supply through the power line by bypassing the plurality of resistors R_inrush. The main contactor Main_MC1 and the auxiliary contactor Sub_MC1 can be operated by a control signal S_T1. The control signal S_T1 may be composed of a plurality of bits (e.g., 6 bits in FIG. 2) for controlling the turn-on/turn-off operations of the main contactor Main_MC1 and the auxiliary contactor Sub_MC1 as described above.

The EMI filter can suppress high-frequency noise of the voltage and current signals transmitted through the contactor and the power line to reduce electromagnetic interference (EMI) transmitted to subsequent circuits.

The differential mode noise filter may be composed of a plurality of capacitors (Cy1˜Cy3), a plurality of resistors (R1˜R3), and a plurality of inductors (Lcon). The differential mode noise filter can suppress differential mode noise included in the voltage and current signals transmitted through the power line. The plurality of capacitors (Cy1˜Cy3) and the plurality of resistors (R1˜R3) bypass high-frequency noise, and the plurality of inductors (Lcon) primarily pass low-frequency power signals.

The PWM converter 1310 may include a plurality of switches (Sah, Sbh, Sch, Sal, Sbl, Scl). The PWM converter 1310 can convert the AC voltage and current signals transmitted through the power line into DC voltage and current through the operation of the plurality of switches (Sah, Sbh, Sch, Sal, Sbl, Scl). The PWM converter 1310 can output the first link voltage Vlink1 through the first output port and the second output port. The plurality of switches (Sah, Sbh, Sch, Sal, Sbl, Scl) are controlled by a control signal S_T2. The control signal S_T2 may be composed of a plurality of bits (e.g., 6 bits in FIG. 2) for controlling the operation of the plurality of switches (Sah, Sbh, Sch, Sal, Sbl, Scl).

Since the configuration of the second power factor correction circuit 1400 is substantially the same as that of the first power factor correction circuit 1300, redundant descriptions are omitted. The PWM converter 1410 of the second power factor correction circuit 1400 can output the second link voltage Vlink2 through the third output port and the fourth output port. Among the two output ports of the second power factor correction circuit 1400, the upper port corresponds to the third output port, and the lower port corresponds to the fourth output port.

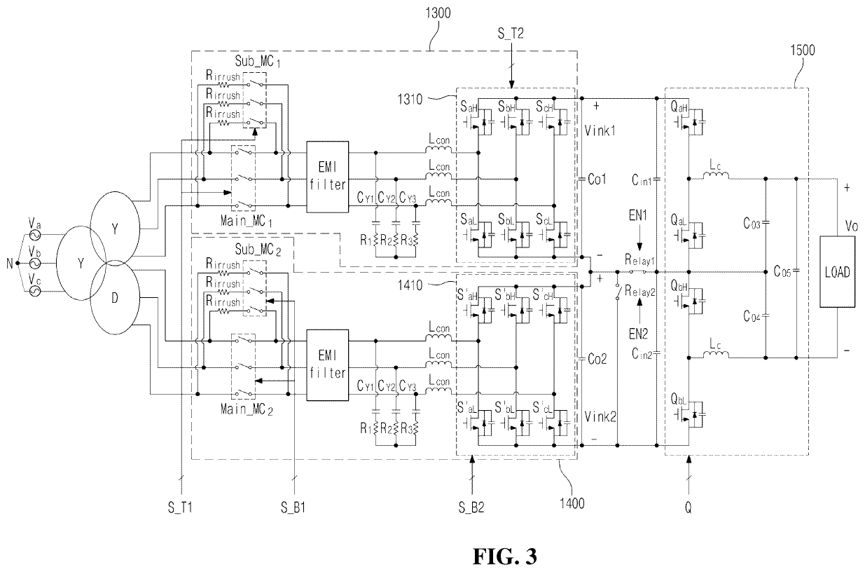

The second power factor correction circuit 1400 is controlled by control signals (S_B1, S_B2). The control signal S_B1 may be composed of a plurality of bits (e.g., 6 bits in FIG. 2) for controlling the turn-on/turn-off operations of the main contactor Main_MC2 and the auxiliary contactor Sub_MC2, and the control signal S_B2 may be composed of a plurality of bits (e.g., 6 bits in FIG. 2) for controlling the operation of the plurality of switches (S′ah, S′bh, S′ch, S′al, S′bl, S′cl). The second power factor correction circuit 1400 may or may not operate depending on the range of the target output voltage. This will be explained in detail with reference to FIG. 3 to FIG. 6.

A first output capacitor Co1 may be connected between the first output port and the second output port of the first power factor correction circuit 1300, and a second output capacitor Co2 may be connected between the third output port and the fourth output port of the second power factor correction circuit 1400. The second output port is connected to the third output port.

The DC-DC converter 1500 may include a first input port, a second input port, and a third input port. Among the three input ports of the DC-DC converter 1500, the upper port corresponds to the first input port, the central port corresponds to the second input port, and the lower port corresponds to the third input port. A first input capacitor Cin1 may be connected between the first input port and the second input port, and a second input capacitor Cin2 may be connected between the second input port and the third input port.

The DC-DC converter 1500 may further include a plurality of switches (Qah, Qal, Qbh, Qbl). The plurality of switches (Qah, Qal, Qbh, Qbl) repeat on-off operations according to the control signal Q and modulate the input voltage to provide an output voltage Vo to the load (Load). The control signal Q may be composed of a plurality of bits (e.g., 4 bits in FIG. 2) for controlling the on-off of the plurality of switches (Qah, Qal, Qbh, Qbl). The control signal Q may be a clock signal or a PWM signal, but the present invention is not limited thereto. As the duty ratio or switching frequency of the control signal Q varies, the turn-on/off time ratio of the plurality of switches (Qah, Qal, Qbh, Qbl) changes, and accordingly, the generated output voltage Vo level and output current can be varied.

The DC-DC converter 1500 may further include an inductor Lc and a plurality of capacitors (Co3, Co4, Co5). These elements are configured to store and transfer energy according to the switching operation of the plurality of switches (Qah, Qal, Qbh, Qbl) to stably supply voltage and current to the load (Load).

The plurality of relay switches may include a first relay switch Relay1 and a second relay switch Relay2. One end of the first relay switch Relay1 may be connected to each of the second output port and the third output port, and the other end may be connected to the second input port of the DC-DC converter 1500. One end of the second relay switch Relay2 may be connected to each of the second output port and the third output port, and the other end may be connected to the third input port of the DC-DC converter 1500. According to the target output voltage, the connection relationship may be changed such that the second relay switch Relay2 is turned off and the first relay switch Relay1 is turned on, whereby each of the second output port and the third output port is connected to the second input port of the DC-DC converter 1500, so that the first link voltage Vlink1 is input to the DC-DC converter 1500 through the first input port and the second input port, and the second link voltage Vlink2 is input to the DC-DC converter 1500 through the second input port and the third input port. Alternatively, according to the target output voltage, the connection relationship may be changed such that the first relay switch Relay1 is turned off and the second relay switch Relay2 is turned on, whereby the third output port is connected with the fourth output port, so that the first link voltage Vlink1 is input to the DC-DC converter 1500 through the first input port and the third input port.

The specific operation of the battery emulator 1000 will be described in detail below.

FIG. 3 to FIG. 6 are diagrams for explaining the specific operation of a battery emulator according to an embodiment of the present invention.

The battery emulator 1000 according to an embodiment of the present invention sets a target output voltage to one of a first high voltage in a first section (1000V˜1500V), a second high voltage in a second section (400V˜1000V), and a low voltage in a third section (50V˜400V), and changes the connection relationship and operation of the battery emulator 1000 accordingly, to efficiently output the voltage corresponding to each section to the load (Load).

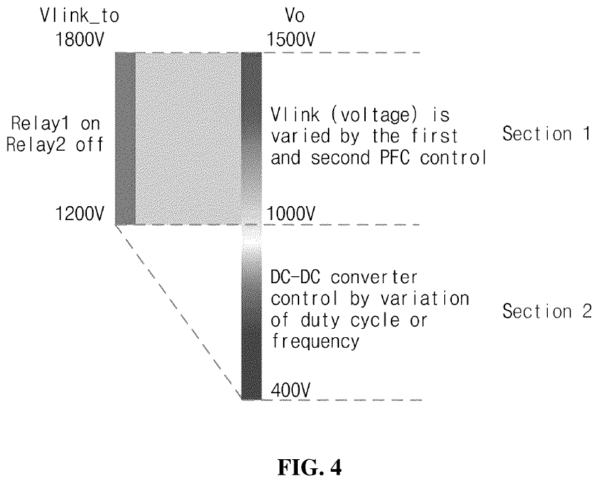

FIG. 3 shows the configuration of the battery emulator 1000, particularly the connection relationship of the plurality of relay switches, when the target output voltage corresponds to the first section or the second section. FIG. 4 shows the relationship between the link voltage Vlink_to and the output voltage Vo according to the target output voltage in the first range and the second section.

When the target output voltage corresponds to the first section, by the control circuit 1600, the plurality of relay switches may be configured to change the connection relationship so that each of the first link voltage Vlink1 and the second link voltage Vlink2 is input to the DC-DC converter 1500. Specifically, the first relay switch Relay1 is turned on to connect each of the second output port and the third output port to the second input port of the DC-DC converter 1500, and the second relay switch Relay2 is turned off. Accordingly, each of the first link voltage Vlink1 and the second link voltage Vlink2 may be input to the DC-DC converter 1500. The total link voltage Vlink_to input to the DC-DC converter 1500 becomes the sum of the first link voltage Vlink1 and the second link voltage Vlink2.

In the first section, as the target output voltage varies, each of the first and second power factor correction circuits (1300, 1400) can linearly vary and output each of the first link voltage Vlink1 and the second link voltage Vlink2, for example, within the range of 600V to 900V. Therefore, the total link voltage Vlink_to can be varied within the range of 1200V to 1800V. The DC-DC converter 1500 can convert the voltage level of the input total link voltage Vlink_to to provide an output voltage Vo in the range of 1000V to 1500V to the load (Load). In the first section, the duty cycle or switching frequency of the control signal Q input to the DC-DC converter 1500 may be maintained without variation, but this is merely an example, and the present invention is not limited thereto.

When the target output voltage corresponds to the second section, by the control circuit 1600, the plurality of relay switches may be configured to maintain the same connection relationship as that in the first section. Accordingly, each of the first link voltage Vlink1 and the second link voltage Vlink2 may be delivered to the input of the DC-DC converter 1500. The total link voltage Vlink_to input to the DC-DC converter 1500 becomes the sum of the first link voltage Vlink1 and the second link voltage Vlink2. Each of the first and second power factor correction circuits (1300, 1400) may be configured to maintain and output each of the first and second link voltages (Vlink1, Vlink2) at a minimum voltage, for example, 600V. Therefore, the total link voltage Vlink_to becomes 1200V.

In the second section, the DC-DC converter 1500 may be configured to operate by receiving a control signal Q whose duty cycle or switching frequency is varied to generate a voltage corresponding to the target output voltage. For example, when the target output voltage is 1000V, the control circuit 1600 may vary the duty ratio of the control signal Q to the maximum and provide it to the DC-DC converter 1500. When the target output voltage is 400V, which is the minimum target output voltage of the second section, the control circuit 1600 may vary the duty ratio of the control signal Q to the minimum and provide it to the DC-DC converter 1500. In this case, since the total link voltage Vlink_to is maintained at a relatively low voltage of 1200V, a minimum duty ratio of the control signal Q for outputting 400V can be secured. According to the change in the duty ratio of the control signal Q, the turn-on/off time ratio of the plurality of switches (Qah, Qal, Qbh, Qbl) changes, and accordingly, the output voltage Vo can be adjusted to correspond to the target output voltage in the second high voltage range (400V˜1000V). Also, for example, the switching frequency can be lowered to reduce power loss under low load conditions, while the switching frequency can be increased to maintain output voltage quality under high load conditions. Therefore, the switching frequency can be varied according to the load condition.

The DC-DC converter 1500 can generate the first high voltage of the first section (1000V˜1500V) and the second high voltage of the second section (400V˜1000V) based on a high link voltage of 1200V˜1800V, thus maintaining high energy efficiency.

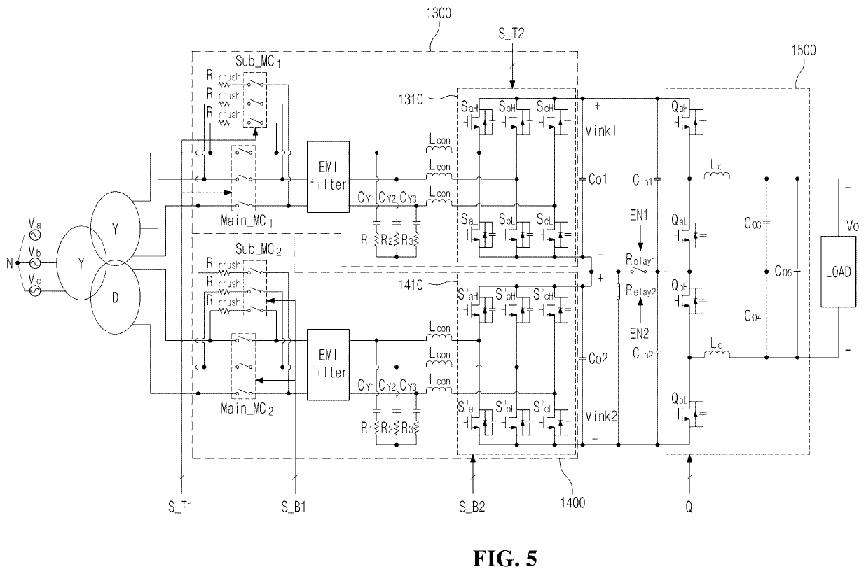

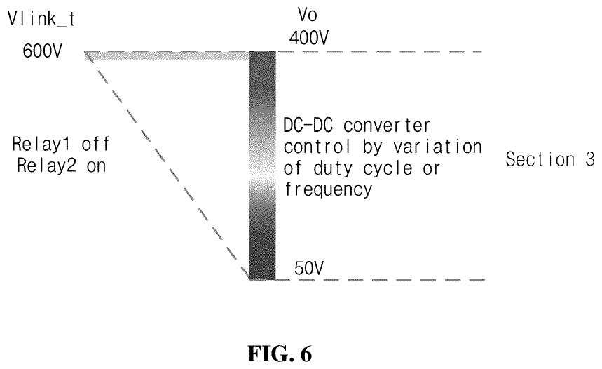

FIG. 5 shows the configuration of the battery emulator 1000, particularly the connection relationship of the plurality of relay switches, when the target output voltage corresponds to the third section. FIG. 6 shows the relationship between the link voltage Vlink_to and the output voltage Vo according to the target output voltage in the third section.

When the target output voltage corresponds to the third section, by the control circuit 1600, the plurality of relay switches may be configured to change the connection relationship so that the first link voltage Vlink1 is input to the DC-DC converter 1500. Specifically, the first relay switch Relay1 may be turned off and the second relay switch Relay2 may be turned on, so that the third output port of the second power factor correction circuit 1400 is connected to the fourth output port.

In the third section, according to the changed connection relationship of the plurality of switches, the first link voltage Vlink1 may be input to the DC-DC converter 1500 through the first input port and the third input port of the DC-DC converter 1500. The total link voltage Vlink_to input to the DC-DC converter 1500 becomes the first link voltage Vlink1. The first power factor correction circuit 1300 may be configured to output the first link voltage Vlink1 at a minimum voltage, for example, 600V, and the total link voltage Vlink_to becomes 600V. Therefore, the DC-DC converter 1500 can generate the low voltage of the third section (50V˜400V) based on a low link voltage of 600V instead of 1200V, thus operating with energy efficiency.

Meanwhile, in the third section, the third output port and the fourth output port of the second power factor correction circuit 1400 are shorted to each other, and the second power factor correction circuit 1400 may be configured to be turned off. Specifically, the main contactor Main_MC2 and the auxiliary contactor Sub_MC2 of the second power factor correction circuit 1400 are turned off by the control signal S_B1, and the plurality of switches (S′ah, S′bh, S′ch, S′al, S′bl, S′cl) of the PWM converter 1410 can also be turned off by the control signal S_B2. In the third section, as the second power factor correction circuit 1400 is turned off, power consumption can be further reduced.

In the third section, the DC-DC converter 1500 may be configured to operate by receiving a control signal Q whose duty cycle or switching frequency is varied to generate a voltage corresponding to the target output voltage. According to the change in the duty ratio of the control signal Q, the turn-on/off time ratio of the plurality of switches (Qah, Qal, Qbh, Qbl) changes, and accordingly, the output voltage Vo can be adjusted to correspond to the target output voltage in the low voltage range (50V˜400V). Also, the switching frequency can be varied according to the load condition.

As described above, the battery emulator 1000 of the present invention can vary the total link voltage Vlink_to according to the range of the target output voltage, and accordingly vary the operations of the first and second power factor correction circuits (1300, 1400) and the DC-DC converter 1500 to generate the output voltage. By this, the battery emulator 1000 of the present invention can perform high-efficiency operation with low power loss across a wide output voltage range (50V˜1500V). The ranges of the target output voltage and the voltages of the first and second link voltages (Vlink1, Vlink2) described above are just one example, and may be changed according to the design of the battery emulator 1000, and the present invention is not limited thereto.

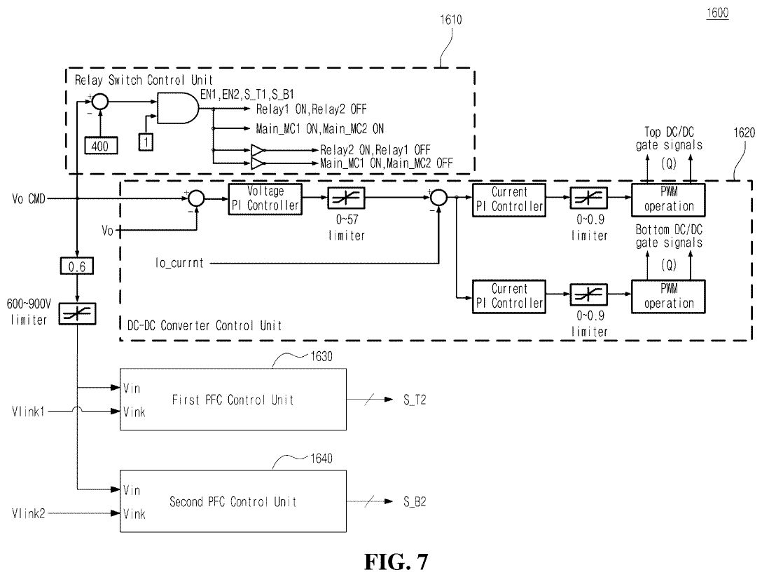

FIG. 7 is an algorithm block diagram for explaining the control operation of the battery emulator by a control circuit according to an embodiment of the present invention.

FIG. 7 shows the operation algorithm of the control circuit 1600 as a block diagram. The control circuit 1600 can be composed of various publicly known circuits for implementing the illustrated algorithm, and the present invention is not limited thereto.

The control circuit 1600 may include a relay switch control unit 1610, a DC-DC converter control unit 1620, a first PFC control unit 1630, and a second PFC control unit 1640. The output voltage Vo is a voltage measured and fed back from the output (Load) of the DC-DC converter 1500, and the target output voltage Vo_CMD may be a digital command indicating the target value of the output voltage Vo. The relay switch control unit 1610, the DC-DC converter control unit 1620, the first PFC control unit 1630, and the second PFC control unit 1640 can each be implemented as a circuit or circuitry

The relay switch control unit 1610 may include an algorithm for controlling the connection relationship of the first relay switch Relay1 and the second relay switch Relay2 according to the target output voltage Vo_CMD. For example, the relay switch control unit 1610 can generate control signals for changing the connection relationship of the plurality of relay switches depending on whether the target output voltage Vo_CMD is in the first or second section, or in the third section. In the embodiment of the present invention, the connection relationship of the plurality of relay switches is changed based on 400V (the boundary between the second section and the third section). Therefore, the relay switch control unit 1610 may include a comparison circuit for comparing 400V with the target output voltage Vo_CMD. When the target output voltage Vo_CMD is 400V or more, the relay switch control unit 1610 generates and outputs control signals (EN1, EN2, S_T1, S_T2, S_B1, S_B2) for turning on the first relay switch Relay1 and turning off the second relay switch Relay2. When the target output voltage Vo_CMD is less than 400V, it can generate and output control signals (EN1, EN2, S_T1, S_T2, S_B1, S_B2) for turning off the first relay switch Relay1, turning on the second relay switch Relay2, and turning off the second power factor correction circuit 1400.

The DC-DC converter control unit 1620 may compare the difference between the target output voltage Vo_CMD and the actual output voltage Vo, generate a target current command, compare the difference with the actual output current Io_current, and generate a control signal Q to compensate for this. The DC-DC converter control unit 1620 can ensure accurate voltage and current supply through a Voltage PI Controller and a Current PI Controller. In addition, the DC-DC converter control unit 1620 may further include a PWM Operation unit to generate and output a control signal Q with an adjusted duty ratio or switching frequency to vary the switch operation of the plurality of switches (Qah, Qal, Qbh, Qbl).

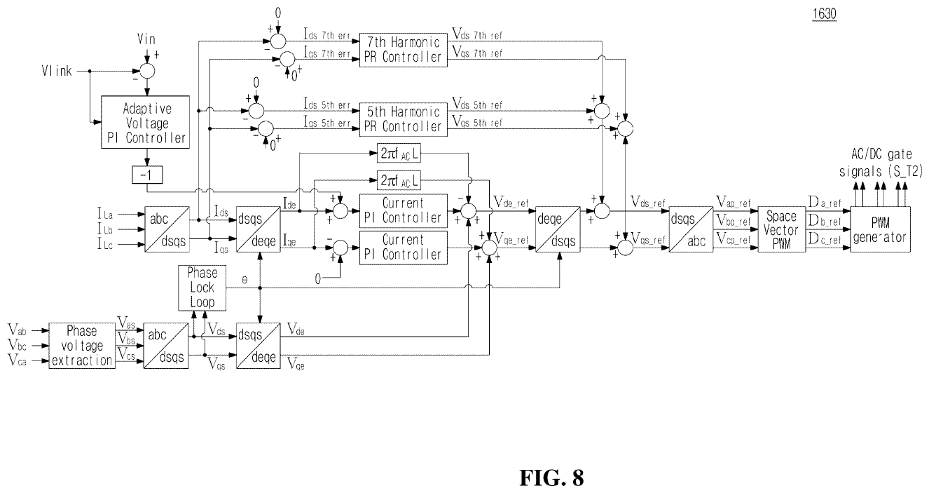

Each of the first PFC control unit 1630 and the second PFC control unit 1640 may generate control signals (S_T2, S_B2) for outputting the voltage levels of the first link voltage Vlink1 and the second link voltage Vlink2 corresponding to each section of the target output voltage Vo_CMD. The algorithm block diagram of the first PFC control unit 1630 will be described with reference to FIG. 8. Since the algorithm block diagram of the second PFC control unit 1640 is substantially the same as that of the first PFC control unit 1630, a description thereof is omitted.

FIG. 8 is an algorithm block diagram for explaining the control operation of the first PFC control unit of FIG. 7.

The first PFC control unit 1630 may receive a voltage (link voltage command) of 0.6 times the target output voltage Vo_CMD as the Vin input (see FIG. 7).

### Equation 1

Link Voltage Command=Target Output Voltage (Vo_CMD)×0.6

Here, the link voltage command may be input to the Vin input of the first PFC control unit 1630 through a 600˜900V limiter. The limiter may limit the voltage so that the link voltage command does not deviate from the range of 600V to 900V.

The first PFC control unit 1630 may compare the link voltage command with the first link voltage Vlink1 input as Vlink, and may generate and output a control signal S_T2 for controlling the plurality of switches (Sah, Sbh, Sch, Sal, Sbl, Scl) to compensate the difference. To generate the control signal S_T2, the first PFC control unit 1630 may further receive the AC voltage and AC current provided through the connection circuit 1200.

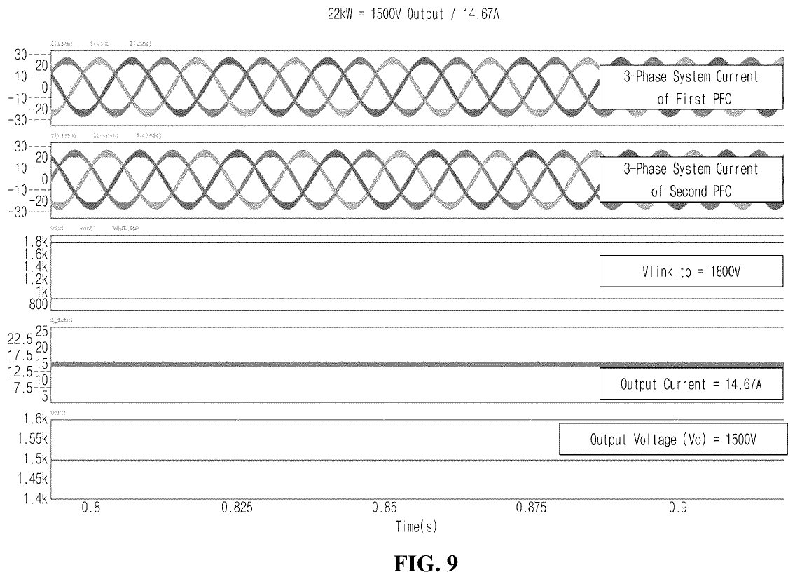

FIG. 9 to FIG. 13 are diagrams showing simulation results of a battery emulator according to an embodiment of the present invention.

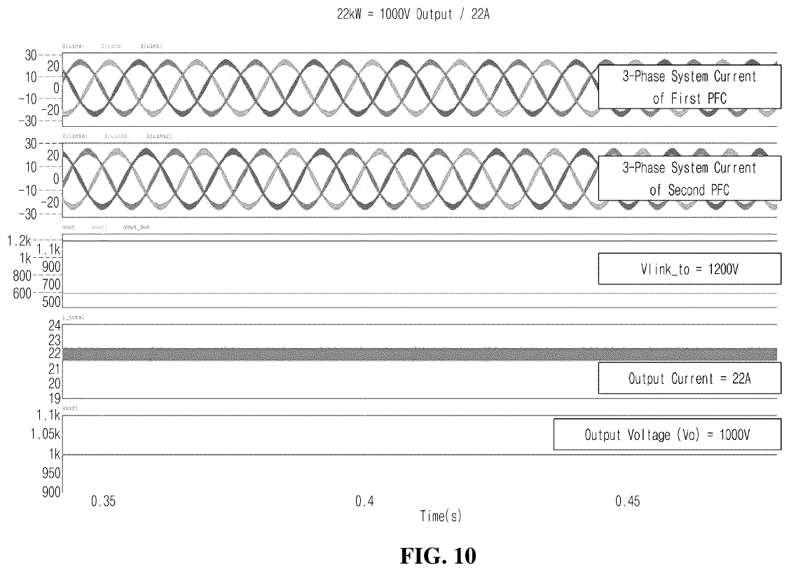

FIG. 9 and FIG. 10 show simulation results when the battery emulator 1000 operates in the first section where the output voltage Vo is in the range of 1000V to 1500V.

FIG. 9 is a simulation result when the output voltage Vo of the battery emulator 1000 is 1500V, and it can be seen that the total link voltage Vlink_to is 1800V. The output current is 14.67 A, and accordingly, the power provided to the load (Load) can be calculated as 22 kW.

FIG. 10 is a simulation result when the output voltage Vo of the battery emulator 1000 is 1000V, and it can be seen that the total link voltage Vlink_to is 1200V, where both the first link voltage Vlink1 and the second link voltage Vlink2 are maintained at the minimum level. The output current is 22 A, and accordingly, the power provided to the load (Load) can be calculated as 22 kW.

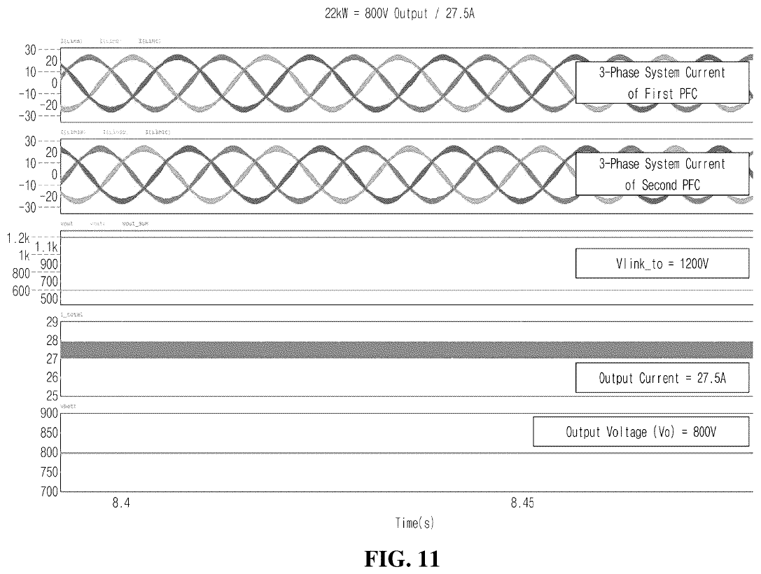

FIG. 11 shows a simulation result when the battery emulator 1000 operates in the second section where the output voltage Vo is in the range of 400V to 1000V.

FIG. 11 is a simulation result when the output voltage Vo of the battery emulator 1000 is 800V, and it can be seen that the total link voltage Vlink_to is 1200V, where both the first link voltage Vlink1 and the second link voltage Vlink2 are maintained at the minimum level. The output current is 27.5 A, and accordingly, the power provided to the load (Load) can be calculated as 22 kW.

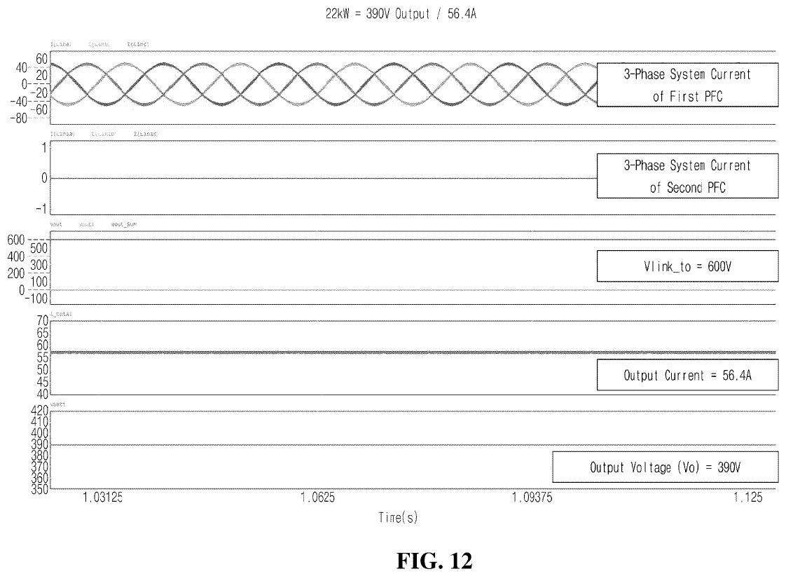

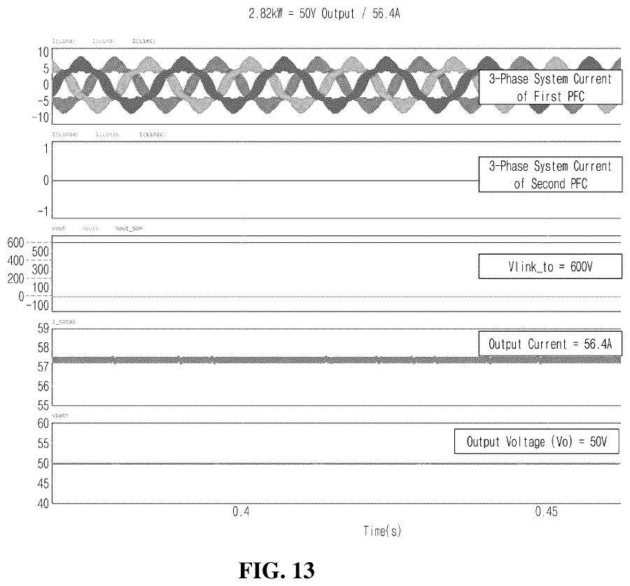

FIG. 12 and FIG. 13 show simulation results when the battery emulator 1000 operates in the third section where the output voltage Vo is in the range of 50V to 400V.

FIG. 12 is a simulation result when the output voltage Vo of the battery emulator 1000 is 390V, and it can be seen that the total link voltage Vlink_to is 600V, which corresponds to the first link voltage Vlink1 maintaining a minimum level of 600V. The output current is 56.4 A, and accordingly, the power provided to the load (Load) can be calculated as 22 kW.

FIG. 13 is a simulation result when the output voltage Vo of the battery emulator 1000 is 50V, and it can be seen that the total link voltage Vlink_to is 600V, which corresponds to the first link voltage Vlink1 maintaining a minimum level of 600V. The output current is measured as 56.4 A, and accordingly, the power provided to the load (Load) can be calculated as 2.82 kW.

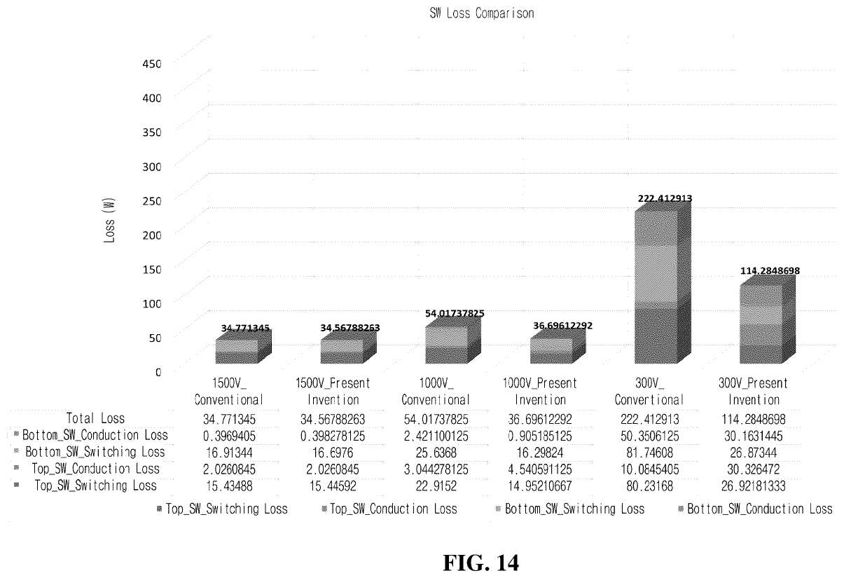

FIG. 14 is a graph for explaining the loss reduction effect of a battery emulator according to an embodiment of the present invention.

Regarding the power loss due to the operation of the battery emulator 1000, the power loss from the DC-DC converter 1500, particularly from the switching of the plurality of switches (Qah, Qal, Qbh, Qbl), accounts for the majority of the total power loss. FIG. 14 is a graph comparing the power loss of the plurality of switches (Qah, Qal, Qbh, Qbl) of the DC-DC converter 1500 according to the output voltage Vo with a conventional configuration. A conventional battery emulator may include one power factor correction circuit and is configured to maintain the total link voltage (Vlink) at 1800V regardless of the range of the output voltage Vo. Such a conventional battery emulator was used as an example for comparison with the present invention. In the graph of FIG. 14, Top_SW refers to the switches (Qah, Qal) located in the upper part of the DC-DC converter 1500, and Bottom_SW refers to the switches (Qbh, Qbl) located in the lower part. Conduction loss is the power loss that occurs due to the internal resistance of a switch when it is turned on and current flows, and switching loss is the loss that occurs when the switch transitions between the on and off states.

According to FIG. 14, under the condition that the output voltage Vo is 1500V, i.e., the total link voltage Vlink_to is 1800V, the DC-DC converter 1500 of the present invention generates a similar level of switching loss and conduction loss as the conventional DC-DC converter. This is because, under the condition that the output voltage Vo is 1500V, the total link voltage Vlink_to of the battery emulator 1000 according to the present invention maintains the same 1800V as the conventional configuration.

On the other hand, under the conditions where the output voltage Vo is 1000V and 300V, a difference in the loss characteristics of the switches appears between the conventional configuration and the configuration of the present invention. According to the graph in FIG. 14, under the condition that the output voltage Vo is 1000V, the switch loss (including switching loss and conduction loss) of the configuration of the present invention was reduced by about 33% compared to the conventional configuration, and under the condition that the output voltage Vo is 300V, it was seen to be reduced by up to about 50%.

The reduction in switch loss in the configuration of the present invention compared to the conventional configuration is due to the voltage level across the plurality of switches (Qah, Qal, Qbh, Qbl) of the DC-DC converter 1500. In the conventional configuration, a high voltage (e.g., 900V) is always applied to a single switch according to the operation of the plurality of switches (Qah, Qal, Qbh, Qbl), maintaining a high level of switching loss. On the other hand, in the battery emulator 1000 according to the present invention, the total link voltage Vlink_to input to the DC-DC converter 1500 varies according to the target output voltage, and therefore, the voltage applied across a single switch according to the operation of the plurality of switches (Qah, Qal, Qbh, Qbl) is reduced to 900V or a lower voltage (e.g., 600V, 300V, etc.). Accordingly, the switching loss in the configuration of the present invention can be significantly reduced compared to the conventional configuration.

As a result, the battery emulator 1000 of the present invention can perform high-efficiency operation with low power loss across a wide output voltage range (50V˜1400V).

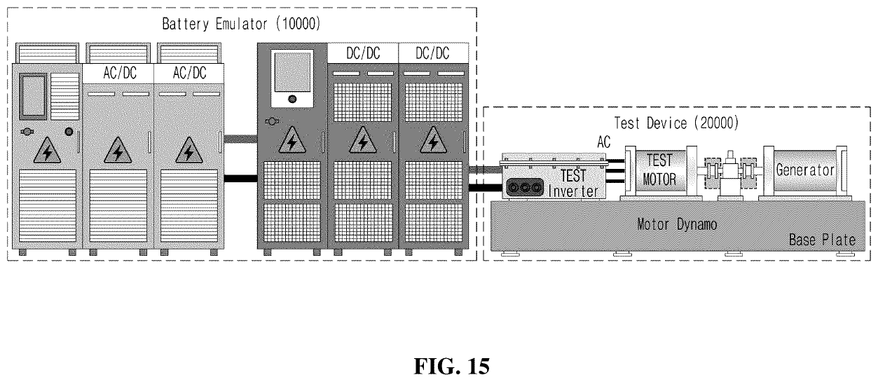

FIG. 15 is a diagram showing a test system including a battery emulator according to an embodiment of the present invention.

The battery emulator 10000 may be the battery emulator 1000 according to the embodiment of the present invention described above. The battery emulator 10000 simulates the characteristics of a real battery under various conditions and provides the voltage and current required by the user to the test device 20000. The test device 20000 may correspond to the load (Load) described in FIG. 1.

The test device 20000 is a device for testing automotive motors and the like. The test device 20000 includes a test inverter, a test motor (automotive motor), and a generator, and these components may be installed on a motor dynamo (Base Plate). The test device 20000 is designed to perform functional tests of the motor based on the power supplied from the battery emulator 10000.

A test system including the battery emulator 10000 according to an embodiment of the present invention can enable efficient and stable testing in environments requiring high-precision voltage and current characteristics, such as automotive systems.

As described above, a person of ordinary skill in the art to which the present disclosure belongs will understand that the present disclosure can be implemented in other specific forms without changing its technical spirit or essential features. Therefore, the above-described embodiments should be understood as illustrative in all respects and not restrictive. The scope of the present disclosure is indicated by the appended claims rather than the detailed description, and all changes or modified forms derived from the meaning and scope of the claims and their equivalent concepts should be interpreted as being included in the scope of the present disclosure.

The features and advantages described in this specification are not all-inclusive, and in particular, many additional features and advantages will be apparent to those skilled in the art in view of the drawings, specification, and claims. Furthermore, it should be noted that the language used in this specification was chosen primarily for readability and instructional purposes, and may not have been chosen to delineate or limit the subject matter of the disclosure.

The foregoing description of the embodiments of the present disclosure has been presented for purposes of illustration. It is not intended to be exhaustive or to limit the disclosure to the precise form disclosed. Those skilled in the art will understand that many modifications and variations are possible in light of the above disclosure.

Therefore, the scope of the present disclosure is not limited by the detailed description, but by any claims of applications based thereon. Therefore, the disclosure of the embodiments of the present disclosure is illustrative and is not intended to limit the scope of the present disclosure described in the following claims.

What is claimed is:

1. A battery emulator, comprising:
a first power factor correction circuit configured to convert a first AC voltage provided from a 3-phase power source through a connection circuit into a DC voltage and output it as a first link voltage;
a second power factor correction circuit configured to convert a second AC voltage provided from the 3-phase power source through the connection circuit into a DC voltage and output it as a second link voltage;
a DC-DC converter configured to convert the voltage level of an input voltage and output it; and
a plurality of relay switches configured such that, according to a target output voltage, the connection relationship is changed so that each of the first link voltage and the second link voltage is input to the DC-DC converter, or so that the second link voltage is not input to the DC-DC converter and only the first link voltage is input to the DC-DC converter.

2. The battery emulator of claim 1, wherein the range of the target output voltage includes a first section higher than a first voltage, a second section between a second voltage lower than the first voltage and the first voltage, and a third section lower than the second voltage.

3. The battery emulator of claim 2, wherein when the target output voltage corresponds to the first section, the plurality of relay switches are configured such that the connection relationship is changed so that each of the first link voltage and the second link voltage is input to the DC-DC converter.

4. The battery emulator of claim 3, wherein when the target output voltage corresponds to the first section, each of the first power factor correction circuit and the second power factor correction circuit is configured to linearly vary and output each of the first link voltage and the second link voltage as the target output voltage varies.

5. The battery emulator of claim 2, wherein when the target output voltage corresponds to the second section, the plurality of relay switches are configured such that the connection relationship is changed so that each of the first link voltage and the second link voltage is input to the DC-DC converter.

6. The battery emulator of claim 5,
wherein when the target output voltage corresponds to the second section:
the first power factor correction circuit is configured to output the first link voltage as a minimum voltage among voltages that the first power factor correction circuit can variably output,
the second power factor correction circuit is configured to output the second link voltage as a minimum voltage among voltages that the second power factor correction circuit can variably output, and
the DC-DC converter is configured to receive a control signal in which a duty cycle or switching frequency is varied to generate a voltage corresponding to the target output voltage.

7. The battery emulator of claim 2, wherein when the target output voltage corresponds to the third section, the plurality of relay switches are configured such that the connection relationship is changed so that the second link voltage is not input to the DC-DC converter and only the first link voltage is input to the DC-DC converter.

8. The battery emulator of claim 7,
wherein when the target output voltage corresponds to the third section:
the first power factor correction circuit is configured to output the first link voltage as a minimum voltage among voltages that the first power factor correction circuit can variably output,
the second power factor correction circuit is configured to be turned off, and
the DC-DC converter is configured to receive a control signal in which a duty cycle or switching frequency is varied to generate a voltage corresponding to the target output voltage.

9. The battery emulator of claim 1,
wherein the first power factor correction circuit includes a first output port and a second output port for outputting the first link voltage,
the second power factor correction circuit includes a third output port and a fourth output port for outputting the second link voltage,
the DC-DC converter includes a first input port, a second input port, and a third input port,
the plurality of relay switches include a first relay switch, one end of which is connected to each of the second output port and the third output port and the other end of which is connected to the second input port, and a second relay switch, one end of which is connected to each of the second output port and the third output port and the other end of which is connected to the third input port, and
according to the target output voltage, the plurality of relay switches are configured to change the connection relationship such that:
the second relay switch is turned off and the first relay switch is turned on, whereby each of the second output port and the third output port is connected to the second input port, so that the first link voltage is input to the DC-DC converter through the first input port and the second input port, and the second link voltage is input to the DC-DC converter through the second input port and the third input port, or,
the first relay switch is turned off and the second relay switch is turned on, whereby the third output port is connected with the fourth output port, so that the first link voltage is input to the DC-DC converter through the first input port and the third input port.

10. An operating method of a battery emulator, comprising the steps of:
in a first power factor correction circuit, converting a first AC voltage provided from a 3-phase power source through a connection circuit into a DC voltage and outputting it as a first link voltage;
in a second power factor correction circuit, converting a second AC voltage provided from the 3-phase power source through the connection circuit into a DC voltage and outputting it as a second link voltage;
in a DC-DC converter, converting the voltage level of an input voltage and outputting it; and
in a plurality of relay switches, changing the connection relationship of the plurality of relay switches according to a target output voltage so that each of the first link voltage and the second link voltage is input to the DC-DC converter, or so that the second link voltage is not input to the DC-DC converter and only the first link voltage is input to the DC-DC converter.
